(19) United States
(12) Patent Application Publication
(10) Pub. No.: US 2007/0198255 A1
(43) Pub. Date: Aug. 23, 2007

(54) Method For Noise Reduction In A Speech Input Signal

(76) Inventors: Tim Fingscheidt, Braunschweig (DE); Sorel Stan, Stamberg (DE)

Correspondence Address: STAAS & HALSEY LLP, SUITE 700, 1201 NEW YORK AVENUE, N.W., WASHINGTON, DC, 20005, US

(21) Appl. No.: 11/578,128

(22) PCT Filed: Nov. 19, 2004
(86) PCT No.: PCT/EP04/53014

§ 371 Date: Oct. 10, 2006

(30) Foreign Application Priority Data
Apr. 8, 2004 (DE) 10 2004 017 486.5

(51) Int. Cl. G10L 21/02

(52) U.S. Cl. 704/228

(57) ABSTRACT

A method reduces for noise in a speech input signal of a speaker by detecting the speech input signal; accessing a determined speech characteristic of the speaker; reducing a noise portion in the speech input signal using the determined speech characteristic of the speaker.

### CROSS REFERENCE TO RELATED APPLICATIONS

This application is based on and hereby claims priority to Application No. PCT/EP2004/053014 filed on Nov. 19, 2004 and German Application No. 10 2004 017 486.5 filed on Apr. 8, 2004, the contents of which are hereby incorporated by reference.

### BACKGROUND OF THE INVENTION

The invention relates to a method for noise reduction in a speech input signal of a speaker as well as to a device for executing the method.

Speech recognition is used to facilitate the operation of electrical devices, especially those in which user interface is miniaturized. To make speech recognition possible, what is known as an acoustic model must be created. Speech commands are trained for this purpose. This training can be undertaken at the factory for example in the case of speaker-independent speech recognition. “Training” in this case is taken to mean that, on the basis of multiple speaking of a speech command, what are known as feature vectors describing the speech command are created. These feature vectors, which are also referred to as prototypes, are then collected in the acoustic model, for example a so-called “Hidden Markov Model” HMM.

The acoustic model is used to determine the probability of the observed feature vectors from a given sequence of speech commands or words selected from the vocabulary during the recognition.

For speech recognition or recognition of continuous speech, in addition to an acoustic model, what is known as a speech model is also used which specifies the probability of consecutive individual words in the speech to be recognized.

The object of current further developments in speech recognition is to increase the speech recognition rate, i.e. to increase the probability that a word or speech command spoken by a user of the electrical device, for example of a mobile communication device such as a mobile telephone, is also detected as such.

Since speech recognition has a multiplicity of uses, it is also used in environments which are disturbed by noise. In this case the speech recognition rates fall drastically since the feature vectors to be found in the acoustic model, for example in the HMM, have been created on the basis of clean speech, i.e. speech untainted by noise or have been “trained”.

This leads to unsatisfactory speech recognition in loud environments, such as on the street, in busy buildings or also in the car.

To increase robustness in relation to ambient noises, for ASR, “(Automatic Speech Recognition”), based on HMMs there are two paths being followed, namely 1) the adaptation of the HMM and 2) the compensation methods in the feature vector domains. The following points should be noted in this context:

1. The adaptation of the HMM or generally of the model, for example via a linear MLLR (“Maximum Likelihood Linear Regression”) method, is not a suitable method of compensating for ambient noise in automatic speech recognition in mobile communication devices. The reason for this are that the mobile device will be used in a plurality of environments and the adaptation to one environment inevitably leads to a bad adaptation to another environment.

2. Compensation methods in the feature vector domains can be implemented in a diversity of ways. A simple way is the application of acoustic improvement methods or “audio enhancement techniques”, such as a Wiener filtering or spectrum subtraction for example. These are aimed at obtaining the power spectrum of “clean speech” from the power spectrum of noise-affected speech. On the basis of the cleaned power spectrum, feature vectors are then calculated which are subjected to speech recognition.

As an alternative there are a plurality of further compensation methods in the feature domain, for example Vector Taylor series (VTS), Vector polynomial approximations (VPS) or Interacting Multiple model (IMM).

The disadvantage of this second approach for improving the robustness in relation to ambient noise is the high level of computing effort required, which in particular prevents application in communication devices with restricted processor and memory resources.

### SUMMARY OF THE INVENTION

Using this related art as its starting point, one possible object of the invention is to create an option for also performing speech recognition with a high speech recognition rate in noisy environments.

The inventors propose that noise reduction is performed not in relation to the environment but in relation to the speaker concerned. It is shown that an improvement the speech recognition can be achieved in this way independent of the environment and thus of the ambient noise.

To this end the speech input signal of a speaker, e.g. of the user of a specific communication device, is recorded and cleaned up using noise reduction based on a speech characteristic of this speaker. This obtains good results in any given environment and at the same time achieves relatively low computing complexity.

The speech characteristic of the speaker can be derived from a suitable mathematical modeling of the speech signal of the speaker which is recorded over a longer period. This involves describing the speech signal by a parameterized function for example. Distortions resulting from noise in the speech input signal are corrected by parameters.

The inventors also propose application of the method for a speech recognition system as well as to a communication device with which this method will be carried out.

There are now various alternatives for implementing the noise reduction method in a communication device. One alternative involves storing the speech characteristic XST-L-SD, which contains the parameters such as probability, expected value, variance, in a non-volatile memory medium, for example a flash memory, during the training of for example speech commands or names, cf. FIG. 5, or of storing them during a special adaptation process. The speaker-dependent description GMM-L-SD is determined from the speaker-independent description GMM-L-SI and the speech characteristic XST-L-SD as shown in FIG. 6. Both speaker-dependent description GMM-L-SD and also speaker-independent description GMM-L-SI are present in the communication device CD, however only the speaker-dependent description GMM-L-SD is active. This implementation especially allows a return to ex-works settings which are kept in the speaker-independent description GMM-L-SI.

A further option is to store the speech characteristic XST-L-SD in a volatile memory. The speaker-dependent description GMM-L-SD is subsequently determined from the speaker-independent description GMM-L-SI and the speech characteristic XST-L-SD, as in FIG. 6. The speaker-dependent description GMM-L-SD created from this replaces the speaker-independent description GMM-L-SI in the non-volatile memory and the speech characteristic XST-L-SD is removed from the temporary memory as soon as the adaptation is completed This has the advantage of needing very little storage space, namely only the space required for the speaker-independent description GMM-L-SI.

### BRIEF DESCRIPTION OF THE DRAWINGS

These and other objects and advantages will become more apparent and more readily appreciated from the following description of the preferred embodiments, taken in conjunction with the accompanying drawings of which:

FIG. 1 a communication device with a speech recognition device;

FIG. 2 a model for noisy speech;

FIG. 3 the execution sequence of speech recognition from a speech input signal;

FIG. 4 the execution sequence of a feature vector extraction;

FIG. 5 the creation of a speech characteristic and also of a speaker-dependent vocabulary (training);

FIG. 6 the creation of a speaker-dependent description on the basis of the speech characteristic and a speaker-independent description; and

FIG. 7 a speech recognition using a speaker-specific noise reduction and a speaker-specific or dependent vocabulary.

### DETAILED DESCRIPTION OF PREFERRED EMBODIMENT

Reference will now be made in detail to the preferred embodiments, examples of which are illustrated in the accompanying drawings, wherein like reference numerals refer to like elements throughout.

FIG. 1 shows a communication device CD with a speech recognition unit SR. The communication device CD can for example be a mobile terminal, a PDA or another especially personalized communication device, i.e. a device primarily assigned to one user.

The communication device CD features a user interface UI, by which the user can operate the communication device. The user interface UI can for example be a keyboard, touch-screen, or also a speech input device. To this end the user interface further features a microphone M for recording an acoustic signal of a speech signal.

For exchange of data the radio communication device also has a transmission interface ANT. The transmission interface can involve a wired or wireless connection to a communication system. In particular the transmission interface ANT is an antenna.

The speech recognition unit SR features at least one central processor unit CPU for performing computing operations and a memory unit SE for storing data.

A speech input signal is for example recorded with the microphone M of the communication device CD. In a real environment the speech input signal or the speech signal is adversely affected by noise.

FIG. 2 shows a noisy speech signal modeled from a clean speech signal. For this modeling the noisy speech signal is shown as an overlay of clean speech and noise. For the modeling in accordance with FIG. 2 it is assumed that the clean speech CS is transmitted through a linear channel LC and only after the transmission is noise N added to the clean speech signal CS in order to obtain noisy speech NS. The linear channel for example involves the transfer function between the mouth and the microphone, which depends on the spatial characteristics of the environment (e.g. car or office).

The noisy speech input signal is recorded, as already stated, with the microphone M for example and subsequently subjected to a noise reduction. This noise reduction can be undertaken for applications in speech recognition within the framework of the feature extraction described at the start.

FIG. 3 now shows a schematic of the processing of the speech input signal SS for subsequent speech recognition.

The speech input signal SS is subjected to a feature extraction FE. The result of this feature extraction is a so-called feature vector FV, on the basis of which speech recognition is undertaken.

In principle each item of speech can be subdivided into specific phonemes for it. Phonemes are sound components or sounds which still allow meaning to be differentiated. Speech recognition can be undertaken using phoneme-based methods.

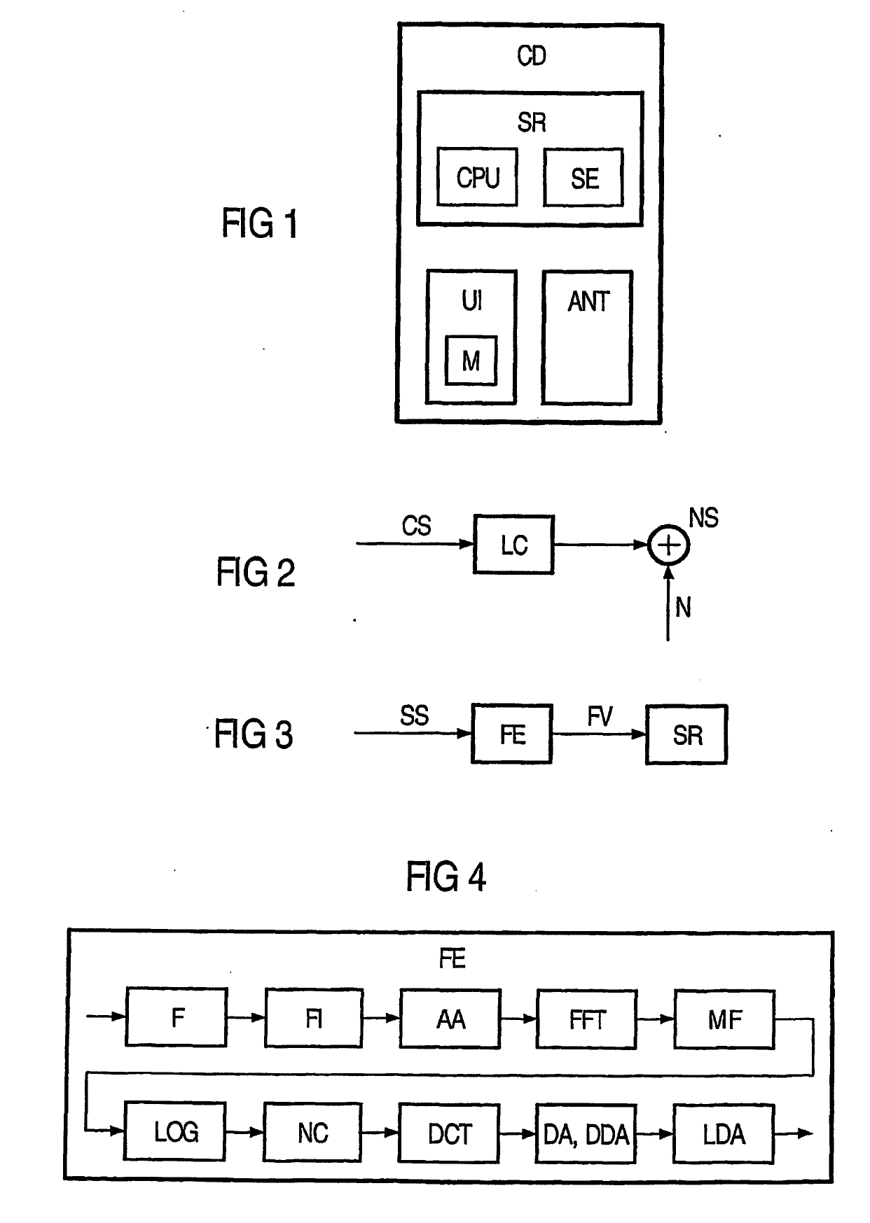

FIG. 4 shows individual steps of a feature extraction FE for phoneme-based speech recognition. The following steps can be included: The fragmentation F of the speech input signal SS in the frame or time window of a predetermined length, for example 10 or 20 milliseconds; Filtering FI of the signal obtained from this with a finite impulse responder filter (FIR), which corresponds to a pre-emphasis” filtering, necessary in order to amplify the higher frequencies in the spectrum of the speech signal.

Furthermore the anti-aliasing AA of what are known as hamming windows is undertaken in order to achieve anti-aliasing, i.e. an avoidance of frequencies not actually determined. Subsequently a Fast Fourier Transformation FFT is performed. The result is a power-spectrum is which the power is plotted against the frequency. This power spectrum is used for adaptation to the sensitivity of the human ear of a so-called mel filter MF with 15 triangular filters. The result in this case would be 15 channel coefficients which are logarithmized LOG for a more efficient representation. A noise reduction NC is now undertaken. Using a discrete cosine transformation DCT what are known as “cepstrum”-channel coefficients are determined, so that now there are 13 channel coefficients present together with the logarithmized energy. The reduce the susceptibility to errors of these coefficients what is known as Delta mapping DA and Delta-Delta mapping DDA are conducted in which relationships to the previous frame and to the frame before last are determined. The relationships are also described with 13 coefficients each, so that after execution of this chain of transformations 39 coefficients are present. These 39 channel coefficients represent the entries or components of a feature vector FV. Optionally a speech-dependent storage space reduction LDA can occur. If this speech-dependent storage space reduction LDA is undertaken, the feature vector FV arising from it is also speech-dependent.

The individual feature vectors FV can now be assigned to the given prototypes. In this way the speech signal is identified, i.e. it is present for example in a phonetic transcription. The phonetic transcription can be assigned a meaning content.

For the noise reduction of the speech input signal a characteristic of the speech of a specific user is included, that is of the user of the communication device, i.e. the noise reduction does not necessarily function satisfactorily for other users. However for a plurality of communication devices which are only ever used by one user, this does not represent a problem. The speech characteristic of a speaker is determined from his or her “long-term” speech signal. To this end the speech signal is accepted over a period which is significantly longer than the time for speaking a speech command in order to determine short-duration deviations from this and really arrive at long-term proprieties characterizing the speech signal. This process is also referred to within the context of the method as (user-specific) training. To record the speech characteristic the speech signal is described using a suitable function, in which case parameters for statistical description of the speech signal can be included. A Gaussian function or a sum of Gaussian functions may be used for example. Describing a speech signal by Gaussian functions is often also referred to as the Gaussian Mixture Model GMM. This can be described by the following Probability Density Function (PDF):

$$p ( {x}_{t} ) = {\sum }_{k = 1}^{K} {w}_{k} p ( {x}_{t} \vert {μ}_{k} , {Σ}_{k} ) with {\sum }_{k = 1}^{K} {w}_{k} = 1 \qquad ( 1 )$$

Whereby p(x₁|μₖ,Σₖ) represents the Gaussian probability density function with an average value μₖ and a covariance matrix Σₖ. The variable xₜ is this case represents a speech signal of the length of one time frame. k is a run variable for the number of the Gaussian functions used up to a number K of Gaussian functions used.

In the case of a diagonal covariance matrix the Gaussian Probability Density Function can be represented as follows:

$$\begin{matrix}p ( {x}_{t} \vert {μ}_{k} , {Σ}_{k} ) = {\prod }_{d = 1}^{D} p ( {x}_{t , d} \vert {μ}_{k , d} , {σ}_{k , d}^{2} ) \\ = {\prod }_{d = 1}^{D} \frac{1}{\sqrt{2 π} {σ}_{k , d}} exp [ - \frac{{( {x}_{t} - {μ}_{k , d} )}^{2}}{2 {σ}_{k , d}^{2}} ]\end{matrix} \qquad ( 2 )$$

in which case a Gaussian function has up to D dimensions, d being the dimension run variable and σ_{k,d} representing the variance of the kth Gaussian function in the dimension d.

The GMM can thus be described as:

$$p ( {x}_{t} ) = {\sum }_{k = 1}^{K} {w}_{k} {\prod }_{d = 1}^{D} \frac{1}{\sqrt{2 π} {σ}_{k , d}} exp [ - \frac{{( {x}_{t} - {μ}_{k , d} )}^{2}}{2 {σ}_{k , d}^{2}} ] with {\sum }_{k = 1}^{K} {w}_{k} = 1. \qquad ( 3 )$$

in which case the GMM, with knowledge of equation (3) and of the time t, is completely described by the statistical variables probability, average value and variance
{wₖ,μ_{k,d},σ_{k,d}²}_{k= 1̅,̅K̅,d= 1̅,̅D̅} (4)

In noise reduction these statistical variables are now used to approximate the speech input signal SS of the speaker distorted by noise or ambient noise to its “normal state” again. To this end the speech input signal SS is also described by the GMM and the statistical variables determined from the speech input signal probability p, expected value and variance are normalized by the statistical variables known from the characteristic. This can for example be done as follows: The probability density function is determined for the kth Gaussian function:

$$p ( k \vert {x}_{t , d} ) = \frac{{w}_{k} p ( {x}_{t , d} \vert {μ}_{k , d} , {σ}_{k , d}^{2} )}{{\sum }_{κ = 1}^{K} {w}_{κ} p ( {x}_{t , d} \vert {μ}_{κ , d} , {σ}_{κ , d}^{2} )} \qquad ( 5 )$$

as well as a corresponding normalization factor for it:

$${n}_{k} = {\sum }_{t = 1}^{T} p ( k \vert {x}_{t} ) \qquad ( 6 )$$

From this the expected values for the speech signal x and the squared speech signal x² are determined:

$$\begin{matrix}{E}_{k , d} ( x ) = \frac{1}{{n}_{k}} {\sum }_{t = 1}^{T} p ( k \vert {x}_{t , d} ) {x}_{t , d} & ( 7 ) \\ {E}_{k , d} ( {x}^{2} ) = \frac{1}{{n}_{k}} {\sum }_{t = 1}^{T} p ( k \vert {x}_{t , d} ) {x}_{t , d}^{2} & ( 8 )\end{matrix}$$

In this way the parameters of the speaker-independent (for example already supplied ex-works), speech-dependent GMM (GMM-L-SI) are adapted using the formula below in order to obtain the speaker-dependent, speech-dependent GMM (GMM-L-SD) for noise reduction. To do this the probability is adapted:

$${w}_{k}^{*} = α [ {a}_{k} \frac{{n}_{k}}{T} + ( 1 - {a}_{k} ) {w}_{k} ] \qquad ( 9 )$$

As is the average value
μ_{k,d}*=bₖE_{k,d}(x)+(1−bₖ)μ_{k,d} (10)
and also the variance
σ_{k,d}²*=cₖE_{k,d}(x²)+(1−cₖ)(σ_{k,d}²+μ_{k,d}²)−μ_{k,d}² (11)
in which case the variables α, aₖ, bₖ, cₖ are suitably selected. These are example determined by trial and error. The values of these variables only determine how much the new observations will be weighted. One option is

$${a}_{k} = {b}_{k} = {c}_{k} = \frac{{n}_{k}}{{n}_{k} + 16}$$

and α is a normalization factor so that Σₖwₖ=1)

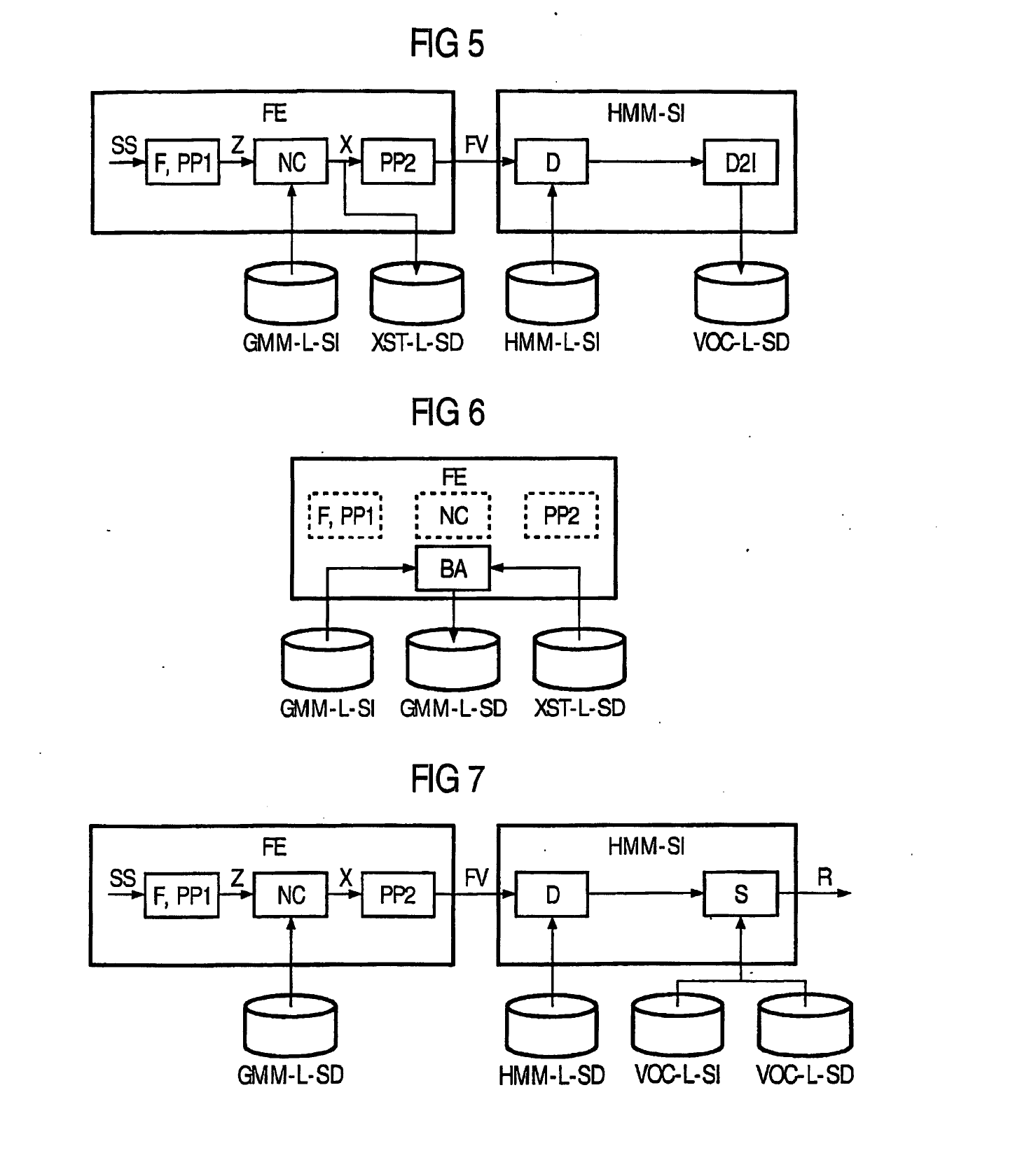

An application of this concept of a speaker-dependent noise reduction is shown in FIG. 5 within the framework of speech recognition. The speech input signal SS is broken down into frames (step F) within the framework of the feature extraction FE and subjected to a first preprocessing PP1. The first preprocessing PP1 contains the steps before the noise reduction NC (cf. FIG. 4). The signal Z produced from this is subjected to known noise reduction NC by a speech-dependent, speaker-independent GMM. The signal X obtained from this is now used in the training situation depicted in FIG. 5 for creating the speaker characteristic XST-L-SD, which naturally also depends on the speech of the speaker. In addition the signal X is subjected to subsequent preprocessing PP2, which includes the steps after the noise reduction NC. The result of the feature extraction FE is a feature vector FV.

To assign a feature vector a distance calculation D to the prototypes from the speaker-independent HMM (SI-HMM) is undertaken.

This distance is converted via a distance-to-index unit D2I into speaker-dependent vocabulary VOC-L-SD, which is naturally also speech-dependent.

FIG. 6 now shows the creation of a speaker-dependent description of the speech signal GMM-L-SD by a Bayesian Adaptation BA based on the speech characteristic XST-L-SD and of the speaker-dependent model for speech description GMM-L-SI. The Bayesian Adaptation is described in the equations 9,10 and 11.

The speaker-dependent description GMM-L-SD created in this way now enters the “test situation”, i.e. is used during the actual speech recognition in FIG. 7 in noise reduction NC. In the speech recognition itself the speaker-dependent vocabulary VOC-L-SD is used alongside the speaker-independent vocabulary VOC-L-SI.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-9. (canceled)

10. A method for noise reduction in a speech input signal from a speaker, comprising:
recording the speech input signal;
accessing a defined speech characteristic of the speaker; and
reducing a noise portion of the speech input signal based on the defined speech characteristic of the speaker.

11. The method in accordance with claim 10, wherein the speech characteristic of the speaker is determined from a speech signal of the speaker via training.

12. The method as claimed in claim 11, wherein the speech characteristic is approximated through a function with at least one variable.

13. The method as claimed in claim 12, wherein
the speech signal of the speaker is approximated via a Gaussian function or a sum of Gaussian functions, and
variables contained in the speech characteristic are represented as averages and variants in the Gaussian function or Gaussian functions.

14. The method as claimed in claim 13, wherein
the speech signal of the speaker is approximated via the sum of Gaussian functions, and
in the sum of Gaussian functions the individual Gaussian functions are weighted and the weighting factors are recorded in the speech characteristic.

15. The method as claimed in claim 13, wherein the Gaussian function is a D-dimensional function, whereby D represents a natural number which is recorded in the speech characteristic.

16. The method as claimed in claim 14, wherein the weighted total of Gaussian functions p(xt) is formed by the following function:
$$p ( {x}_{t} ) = {\sum }_{k = 1}^{K} {w}_{k} {\prod }_{d = 1}^{D} \frac{1}{\sqrt{2 π} {σ}_{k , d}} exp [ - \frac{{( {x}_{t} - {μ}_{k , d} )}^{2}}{2 {σ}_{k , d}^{2}} ] mit {\sum }_{k = 1}^{K} {w}_{k} = 1 ,$$
with xₜ being a speech signal one time frame in length, k being a run index describing the Gaussian function, K being a total number of Gaussian functions which are used to describe the speech signal, μ_{k,d} representing an expected value of the kth Gaussian function in a dimension d of a total number of dimensions D, σ_{k,d} being a variance associated with a kth Gaussian function in the dth dimension and wₖ being a weighting factor for the kth, D-dimensional Gaussian function.

17. The method as claimed in claim 14, wherein the Gaussian function is a D-dimensional function, whereby D represents a natural number which is recorded in the speech characteristic.

18. The method as claimed in claim 17, wherein the weighted total of Gaussian functions p(xt) is formed by the following function:
$$p ( {x}_{t} ) = {\sum }_{k = 1}^{K} {w}_{k} {\prod }_{d = 1}^{D} \frac{1}{\sqrt{2 π} {σ}_{k , d}} exp [ - \frac{{( {x}_{t} - {μ}_{k , d} )}^{2}}{2 {σ}_{k , d}^{2}} ] mit {\sum }_{k = 1}^{K} {w}_{k} = 1 ,$$
with xₜ being a speech signal one time frame in length, k being a run index describing the Gaussian function, K being a total number of Gaussian functions which are used to describe the speech signal, μ_{k,d} representing an expected value of the kth Gaussian function in a dimension d of a total number of dimensions D, σ_{k,d} being a variance associated with a kth Gaussian function in the dth dimension and wₖ being a weighting factor for the kth, D-dimensional Gaussian function.

19. A speech recognition method for at least one speech command in a speech input signal of a speaker, comprising:
reducing noise in the speech input signal by a process comprising:
recording the speech input signal;
accessing a defined speech characteristic of the speaker; and
reducing a noise portion of the speech input signal based on the defined speech characteristic of the speaker;
b) extracting of feature vectors from the speech input signal; and
c) recognizing the speech command based on a comparison of the feature vectors with defined prototype feature vectors.

20. The method in accordance with claim 19, wherein in reducing noise in the speech input signal:
the speech characteristic of the speaker is determined from a speech signal of the speaker via training,
the speech signal of the speaker is approximated via a sum of Gaussian functions,
variables contained in the speech characteristic are represented as averages and variants in the Gaussian functions,
in the sum of Gaussian functions the individual Gaussian functions are weighted and the weighting factors are recorded in the speech characteristic,
the Gaussian function is a D-dimensional Gaussian function, whereby D represents a natural number which is recorded in the speech characteristic, and
the weighted total of Gaussian functions p(xt) is formed by the following function:
$$p ( {x}_{t} ) = {\sum }_{k = 1}^{K} {w}_{k} {\prod }_{d = 1}^{D} \frac{1}{\sqrt{2 π} {σ}_{k , d}} exp [ - \frac{{( {x}_{t} - {μ}_{k , d} )}^{2}}{2 {σ}_{k , d}^{2}} ] mit {\sum }_{k = 1}^{K} {w}_{k} = 1 ,$$
with xₜ being a speech signal one time frame in length, k being a run index describing the Gaussian function, K being a total number of Gaussian functions which are used to describe the speech signal, μ_{k,d} representing an expected value of the kth Gaussian function in a dimension d of a total number of dimensions D, σ_{k,d} being a variance associated with a kth Gaussian function in the dth dimension and wₖ being a weighting factor for the kth, D-dimensional Gaussian function.

21. A communication device comprising:
a microphone for accepting a speech signal from a speaker;
a memory to store a defined speech characteristic of the speaker; and
a central processor unit for processing the speech signal and reducing noise in the speech input signal by a process comprising:
recording the speech input signal;
accessing the defined speech characteristic of the speaker; and
reducing a noise portion of the speech input signal based on the defined speech characteristic of the speaker.

22. The communication device in accordance with claim 21, wherein in reducing noise in the speech input signal:
the speech characteristic of the speaker is determined from a speech signal of the speaker via training,
variables contained in the speech characteristic are represented as averages and variants in the Gaussian functions,
in the sum of Gaussian functions the individual Gaussian functions are weighted and the weighting factors are recorded in the speech characteristic,
the Gaussian function is a D-dimensional Gaussian function, whereby D represents a natural number which is recorded in the speech characteristic, and
the weighted total of Gaussian functions p(xt) is formed by the following function:
$$p ( {x}_{t} ) = {\sum }_{k = 1}^{K} {w}_{k} {\prod }_{d = 1}^{D} \frac{1}{\sqrt{2 π} {σ}_{k , d}} exp [ - \frac{{( {x}_{t} - {μ}_{k , d} )}^{2}}{2 {σ}_{k , d}^{2}} ] mit {\sum }_{k = 1}^{K} {w}_{k} = 1 ,$$
with xₜ being a speech signal one time frame in length, k being a run index describing the Gaussian function, K being a total number of Gaussian functions which are used to describe the speech signal, μ_{k,d} representing an expected value of the kth Gaussian function in a dimension d of a total number of dimensions D, σ_{k,d} being a variance associated with a kth Gaussian function in the dth dimension and wₖ being a weighting factor for the kth, D-dimensional Gaussian function.
